(19) United States
(12) Patent Application Publication
(10) Pub. No.: US 2026/0263943 A1
(43) Pub. Date: Sep. 10, 2026

(54) ONE OR MORE COMPUTER-READABLE STORAGE MEDIA, COMPUTER-IMPLEMENTED METHOD, AND INFORMATION PROCESSING SYSTEM

(71) Applicant: NINTENDO CO., LTD., Kyoto (JP)

(72) Inventors: Masahiro KISHI, Kyoto (JP); Shintaro JIKUMARU, Kyoto (JP)

(21) Appl. No.: 19/547,336

(22) Filed: Feb. 23, 2026

(30) Foreign Application Priority Data
Mar. 6, 2025 (JP) 2025-035677

(51) Int. Cl. A63F 13/69; A63F 13/56; A63F 13/577; A63F 13/803

(52) U.S. Cl. CPC A63F 13/69; A63F 13/56; A63F 13/577; A63F 13/803; A63F 2300/638

(57) ABSTRACT

An example of an information processing system of the exemplary embodiment includes: setting, on a field, a course selected from among a plurality of courses respectively defined in partial regions of the field; starting a race involving a plurality of mobile characters including an operation target character on the course; during the race, when any one of the mobile characters makes a first interference instruction to other mobile characters, changing at least one of the other mobile characters into a first character, and placing a second character that is an obstacle to traveling on the course.

### CROSS REFERENCE TO RELATED APPLICATION

This application claims priority to Japanese Patent Application No. 2025-035677, filed on Mar. 6, 2025, the entire contents of which are incorporated herein by reference.

### FIELD

The technique shown here relates to one or more computer-readable storage media having stored therein a game program, a computer-implemented method, an information processing system, and an information processing apparatus that enable execution of a racing game.

### BACKGROUND AND SUMMARY

Conventionally, in racing games in which a player character is moved, there have been racing games in which it is possible to interfere with traveling of other mobile characters.

In the racing games in which a mobile character travels while interfering with traveling of other mobile characters, there is a demand for providing a new interference method.

The exemplary embodiment discloses a game program, a computer-implemented method, an information processing system, and an information processing apparatus that enable a new form of interference in a racing game in which a mobile character travels while interfering with traveling of other mobile characters.

The exemplary embodiment adopts the following configurations, for example.

### First Configuration

A first configuration of the exemplary embodiment is one or more non-transitory computer-readable storage media having stored therein instructions that, when executed, cause one or more processors to execute game processing comprising:
based on an operation input, causing an operation target character to travel on a field in a virtual space;
regarding a race involving a plurality of mobile characters including the operation target character, setting a course on the field, the course having been determined as a course to be used for the race from among a plurality of courses respectively defined in partial regions of the field, and starting the race;
on the field, causing the operation target character and the mobile characters to travel along the course, thereby conducting the race; and
during the race, when any one of the mobile characters makes a first interference instruction to other mobile characters, changing at least one of the other mobile characters into a first character, and
placing a second character that is an obstacle to traveling on the course.

With the above configuration, a plurality of effects, such as change in appearance of a mobile character and placement of an obstacle, can be generated in response to the first interference instruction, whereby a new form of interference can be performed in the racing game by combining the plurality of effects.

### Second Configuration

In a second configuration based on the first configuration, each of the first character and the second character may be determined from among a plurality of types of characters, based on a location on the field where the first interference instruction is made.

With the above configuration, regional characteristics can be imparted to the first character into which a mobile character changes.

### Third Configuration

In a third configuration based on the second configuration, the plurality of types of characters may include characters that are respectively set in association with a plurality of regions defined by dividing the field. At least the first character may be determined through a lottery process from among candidates including at least a character that is associated with the region including a position on the field where the first interference instruction is made.

With the above configuration, it is possible to determine a character associated with the region including the position where the first interference instruction is made, from among the plurality of types of characters.

### Fourth Configuration

In a fourth configuration based on the third configuration, the first character may be determined through a lottery process from among candidates including at least a character that is associated with the region including a position on the field where the first interference instruction is made. The second character may be determined through a lottery process from among candidates corresponding to the determined first character.

With the above configuration, a character associated with the region including the position where the first interference instruction is made, can be determined as the first character from among the plurality of types of characters, and the second character can be determined based on the determined first character.

### Fifth Configuration

In a fifth configuration based on any one of the second to fourth configurations, the game processing may further include: before the race, selecting a character to be the operation target character from among a plurality of selectable characters; and if the first character into which the mobile character is changed due to the first interference instruction is not included in the selectable characters, adding the first character to the selectable characters.

With the above configuration, since the characters based on the locations on the field are released as selectable characters, the player is allowed to conduct races at various locations.

### Sixth Configuration

In a sixth configuration based on the fifth configuration, the game processing may further include returning the mobile character changed into the first character, to the character before the change, after a certain time has elapsed.

With the above configuration, the first character can be returned to the original character selected by the player, and the first character can be added to the selectable characters. Therefore, the player can play the game without feeling much disadvantage even when subjected to an interference.

### Seventh Configuration

In a seventh configuration based on any one of the first to sixth configurations, the game processing may include, based on the first interference instruction, placing the second character, at least, at a position along the course that is ahead of the mobile character at the front of the race.

With the above configuration, it is possible to place the second character that serves as an obstacle, at a location where the obstacle affects an upper-rank mobile character while also potentially affecting mobile characters other than the upper-rank mobile character.

### Eighth Configuration

In an eighth configuration based on the seventh configuration, the game processing may include: based on the first interference instruction, moving a third character forward along the course, from the position of the mobile character that has made the first interference instruction; changing the mobile character, which comes into contact with a determination shape that is set in conjunction with the third character during forward movement, into the first character; and placing the second character after the third character has moved to the front position.

With the above configuration, by performing change of a mobile character and placement of an obstacle character while moving the third character, the effect corresponding to the first interference instruction can be made easier to understand.

### Ninth Configuration

In a ninth configuration based on the eighth configuration, the game processing may include, when the position where the second character is placed is a position on the field where placement of the second character is inhibited, placing the second character after changing the second character into a character that can be placed.

With the above configuration, a placeable character can be placed according to the position on the field.

Another configuration may be an information processing system, an information processing apparatus, or a computer-implemented method for executing the above game processing.

According to the exemplary embodiment, a new form of interference can be performed in a racing game.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the entirety of a field F in a virtual space;

FIG. 4 is an example non-limiting diagram showing an example of an intra-base route AR1 set in a base area A1;

FIG. 5 is an example non-limiting diagram showing an example of a game image displayed on a display device during a racing game of the exemplary embodiment;

FIG. 6 is an example non-limiting diagram showing an example of a game image when a player character 50 comes into contact with an item acquisition object 70 and acquires a specific item X;

FIG. 7 is an example non-limiting diagram showing an example of a game image when a player character 50 uses a specific item X;

FIG. 8 is an example non-limiting diagram showing an example of a game image after the game image shown in FIG. 7 was displayed, and after a specific item X hit another mobile character 51;

FIG. 9 is an example non-limiting diagram showing an example of a game image after the game image shown in FIG. 8 was displayed, and after a specific item X hit a leading other mobile character 52;

FIG. 10 is an example non-limiting diagram showing an example of a game image after the game image shown in FIG. 9 was displayed, and after a specific item X hit a leading other mobile character 52;

FIG. 11 is an example non-limiting diagram showing an example of the relationship among a region where a mobile character having used a specific item X is present, a specific character into which a mobile character hit by the specific item X changes, and an obstacle character that appears;

FIG. 12 is an example non-limiting diagram showing an example of various data stored in a game system 1;

FIG. 13 is an example non-limiting flowchart showing an example of game processing;

FIG. 14 is an example non-limiting flowchart showing an example of a player character control process in step S14; and

FIG. 15 is an example non-limiting flowchart showing an example of a specific item control process in step S16.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an upper button, a lower button, a right button, and a left button, a plurality of buttons (an A-button, a B-button, an X-button, a Y-button, an L-button, and an R-button) and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

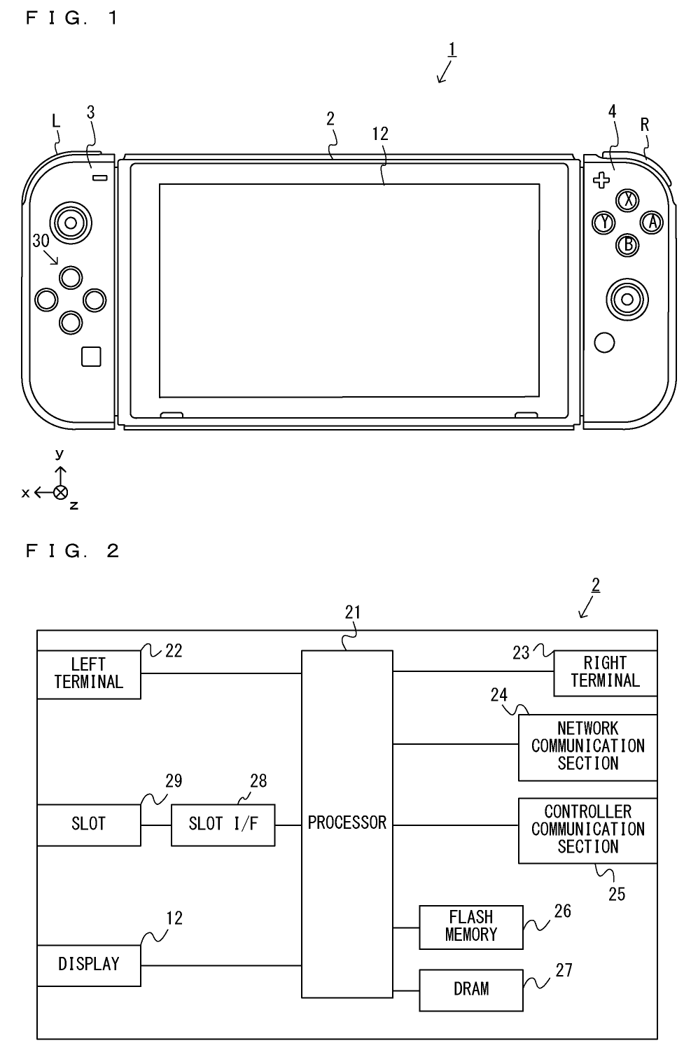

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Outline of Game

Next, the outline of a game executed in the game system 1 will be described. The game of the exemplary embodiment is a racing game in which a plurality of mobile characters move in a virtual space (game space). For example, a main body apparatus 2 communicates with another main body apparatus 2 via a network (e.g., the Internet), whereby a plurality of players play a racing game in a multiplayer mode. Hereinafter, a case where a racing game is played in a multiplayer mode will be described. A single player may play a racing game in a single-player mode.

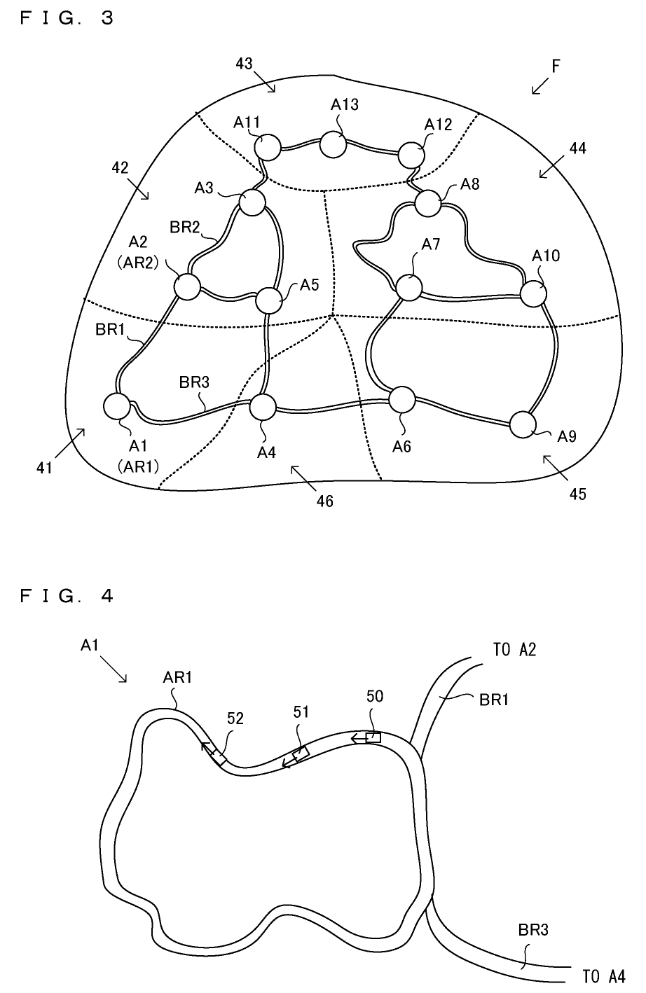

First, a field in a virtual space where a racing game according to the exemplary embodiment is played will be described. FIG. 3 shows an example of the entirety of a field F in a virtual space.

In the exemplary embodiment, a vast field F is set in the virtual space (game space). As shown in FIG. 3, a plurality of base areas A are set on the field F in the virtual space. In each base area A, an intra-base route AR along which the player character can circulate is set. In addition, the plurality of base areas are connected by an inter-base route BR along which the player character can travel. Hereinafter, an intra-base route AR and an inter-base route BR are collectively referred to as “route R”.

The field F is divided into a plurality of regions (e.g., 41 to 46) as indicated by broken lines in FIG. 3. For example, a region 41 includes a base area A1. A region 42 includes a base area A2, a base area A3, and a base area A5. The terrain and climate differ from region to region. For example, the region 41 may be a region with abundant water, and the region 42 may be a forest region.

The player can select any one of the plurality of courses set on the field, and play the racing game on the selected course. For example, when the base area A1 is selected, a course, in which the intra-base route AR1 set in the base area A1 is circulated multiple times, is set, and a racing game, in which a plurality of mobile characters including the player character move along this course, is played. When the base area A2 is selected, a course, in which the intra-base route AR2 set in the base area A2 is circulated multiple times, is set, and a racing game is played along this course. When a course including at least one inter-base route BR is selected, a course including the inter-base route BR is set, and a racing game is played along this course. For example, a course including the inter-base route BR1 and the intra-base route AR2 is set, and a racing game is played along this course.

FIG. 4 shows an example of the intra-base route AR1 set in the base area A1. For example, a course path is set along the route AR1. The course path is a route, from a start point to a goal point, assumed to be taken by the mobile characters (50 to 52). The plurality of mobile characters start from the start point, move along the set course, and reach the goal point. If a mobile character deviates from the course path, the mobile character is returned to the course path.

Before starting the racing game, the player selects, as a player character, any one of a plurality of selectable characters, on a character selection screen. In addition, before starting the racing game, the player selects any one of a plurality of selectable vehicle objects, on a vehicle object selection screen. The player character and vehicle object selected by the player are placed at the start point, and the racing game is started.

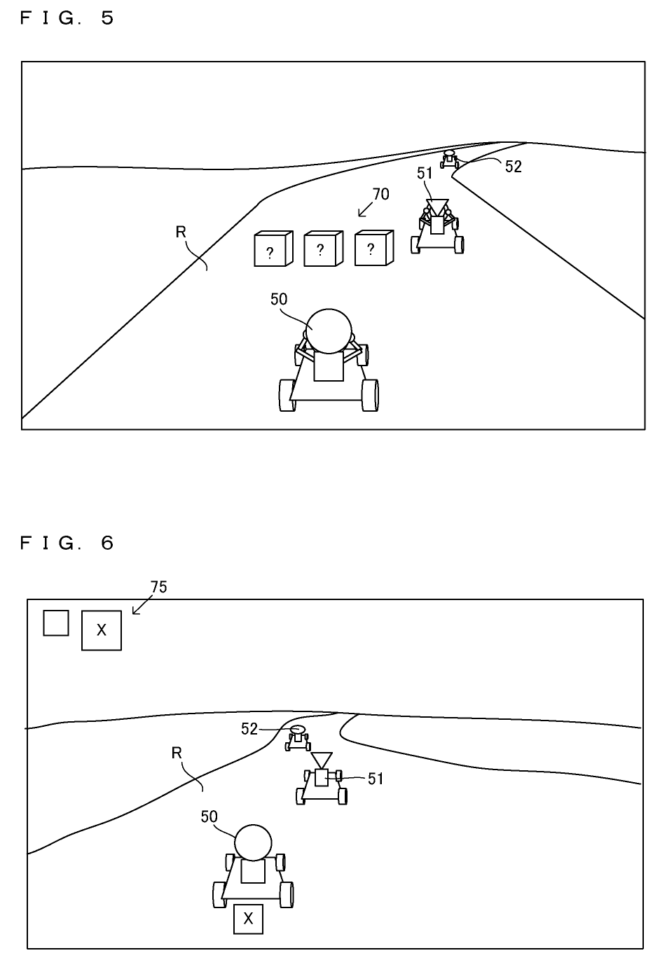

FIG. 5 shows an example of a game image displayed on the display device during the racing game of the exemplary embodiment.

As shown in FIG. 5, a plurality of mobile characters including a player character 50 are traveling on a route R. Each mobile character moves in the virtual space while riding on a vehicle object.

The player character 50 is operated by the player of the main body apparatus 2, and is controlled based on operation data from the controllers 3 and 4. Ahead of the player character 50, another mobile character 51, which is an opponent of the player character 50, is traveling. The other mobile character 51 is, for example, a character operated by a second player, and is controlled based on game data received from the main body apparatus 2 of the second player. Ahead of the other mobile character 51, still another mobile character 52, which is an opponent of the player character 50, is traveling. The other mobile character 52 is a character operated by a third player, and is controlled based on game data received from the main body apparatus 2 of the third player. In addition to the other mobile characters 51 and 52, a plurality of other mobile characters participate in the racing game. When the racing game is played in the single-player mode, the plurality of other mobile characters are automatically controlled by the processor 21. In the racing game played in the multiplayer mode, at least one of the plurality of other mobile characters may be a character (non-player character) automatically controlled by the processor 21.

The characters 50 to 52 are characters selectable by the player through the character selection screen, and are initially set to be selectable. A character initially set to be selectable on the character selection screen is referred to as “normal character”.

As shown in FIG. 5, an item acquisition object 70 is placed in the virtual space. The item acquisition object 70 is an object that causes a mobile character to acquire an item. Specifically, when the mobile character comes into contact with the item acquisition object 70, an item is given to the mobile character from among a plurality of types of items. When the item is given to the mobile character, the mobile character holds the item. When an item use instruction is made in the state where the mobile character holds an item, this item is used. Each mobile character can hold up to a predetermined number of items (e.g., two items) at the same time. The items held by the mobile character are used in the order in which they were acquired.

An item generates an effect corresponding to its type when it is used. For example, a plurality of types of items, such as an item that temporarily increases the speed of a mobile character using the item, and an item having an attack effect (travel-interference effect) against other mobile characters, are prepared. Hereinafter, a specific item X among the plurality of type of items will be described.

FIG. 6 shows an example of a game image when the player character 50 comes into contact with the item acquisition object 70 and acquires a specific item X.

For example, when the player character 50 comes into contact with the item acquisition object 70, a specific item X is given to the player character 50, and the player character 50 holds the specific item X. In the state where the player character 50 holds the specific item X, an icon indicating the specific item X is displayed in an item holding area 75. Furthermore, in the state where the player character 50 holds a specific item X, an icon of the specific item X is displayed near the player character 50.

When the player makes an item use instruction in the state shown in FIG. 6, the player character 50 uses the specific item X. The specific item X has an interference effect on other mobile characters.

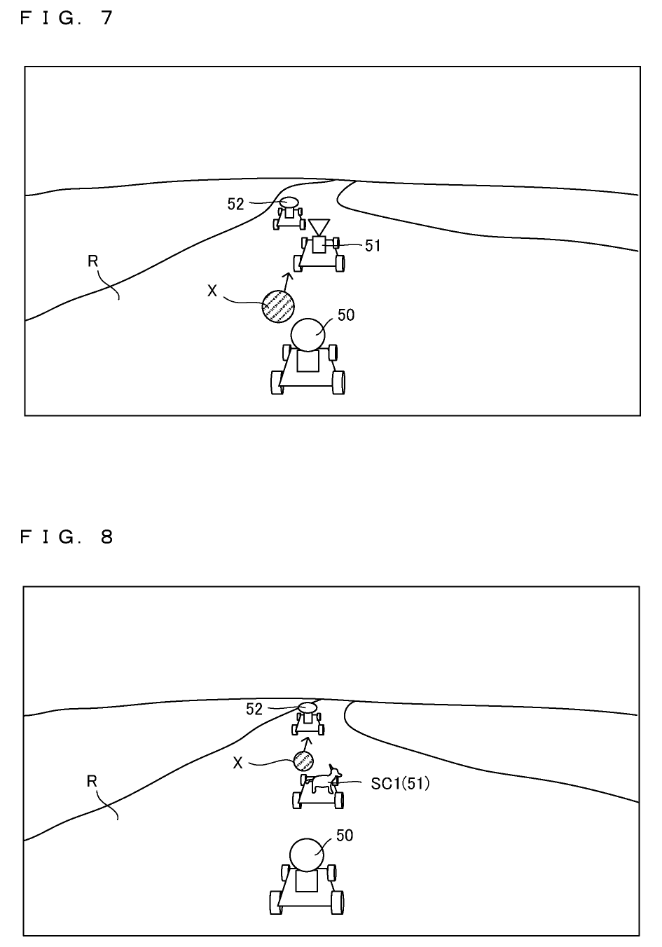

FIG. 7 shows an example of a game image when the player character 50 uses a specific item X.

As shown in FIG. 7, when the specific item X is used, the specific item X starts moving forward from the position of the player character 50. The specific item X is, for example, a character that moves along a route R while floating above the ground. The specific item X automatically moves along a predetermined course path. For example, the specific item X moves forward (toward the goal) along the center line of the route R.

The specific item X has a hitting determination region (or hitting determination shape) that is not displayed in the game image. The hitting determination region is larger than the specific item X itself, and has, for example, a width approximately equal to the width of the route R and a certain size in the vertical direction. In addition, the speed at which the specific item X moves is faster than the speeds of the player character 50 and the other mobile characters. Therefore, the specific item X, which starts moving from the position of the player character 50, hits the other another mobile characters 51 and 52 that are traveling on the route R ahead of the player character 50.

FIG. 8 shows an example of a game image displayed after the game image shown in FIG. 7 was displayed, and after the specific item X hit the other mobile character 51.

As shown in FIG. 8, when the specific item X hits the other mobile character 51, the other mobile character 51 temporarily enters a disadvantageous state in the race (e.g., a difficult-to-operate state or a low-speed state), and thereafter changes into a specific character SC1. Only the other mobile character 51 riding on the vehicle object changes into the specific character SC1, and the vehicle object itself does not change. When the specific item X hits the other mobile character 51, the other mobile character 51 may not necessarily enter the temporarily disadvantageous state in the race.

The specific character SC1 is a character whose appearance is different from the character 51, and may be, for example, a character imitating an animal. The character 51 and the specific character SC1 have different attributes. For example, the specific character SC1 may have a higher maximum speed than the character 51, but a lower bending performance. However, the overall capabilities of the character 51 and the specific character SC1 in the racing game are approximately the same.

The second player continues the racing game by operating the specific character SC1 after the change as a player character. The specific character SC1 operated by the second player is referred to as “other mobile character SC1 (51)”. Even after the specific item X hit the other mobile character 51, the specific item X moves forward along the course path. Then, the specific item X hits the leading other mobile character 52.

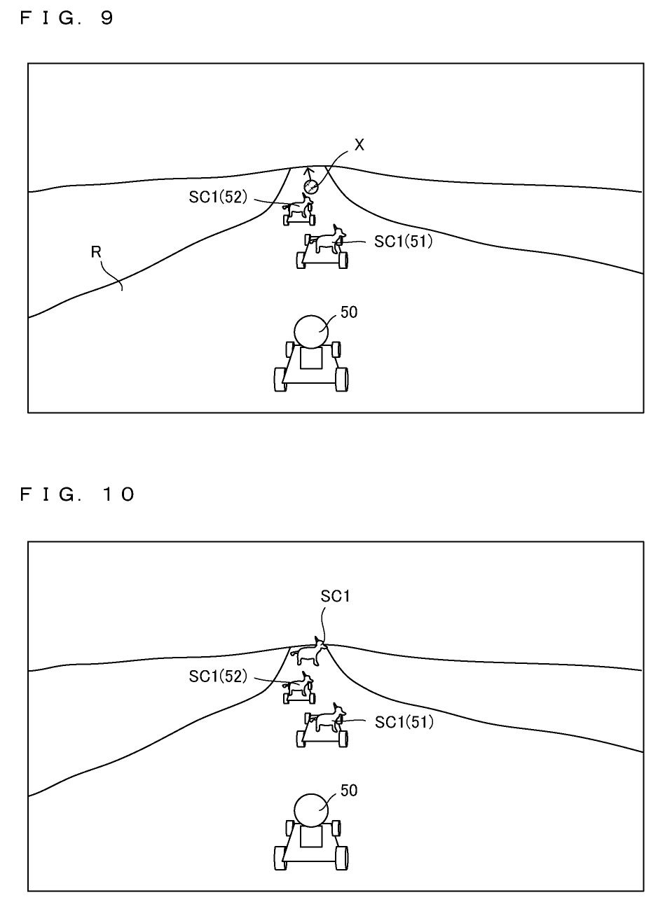

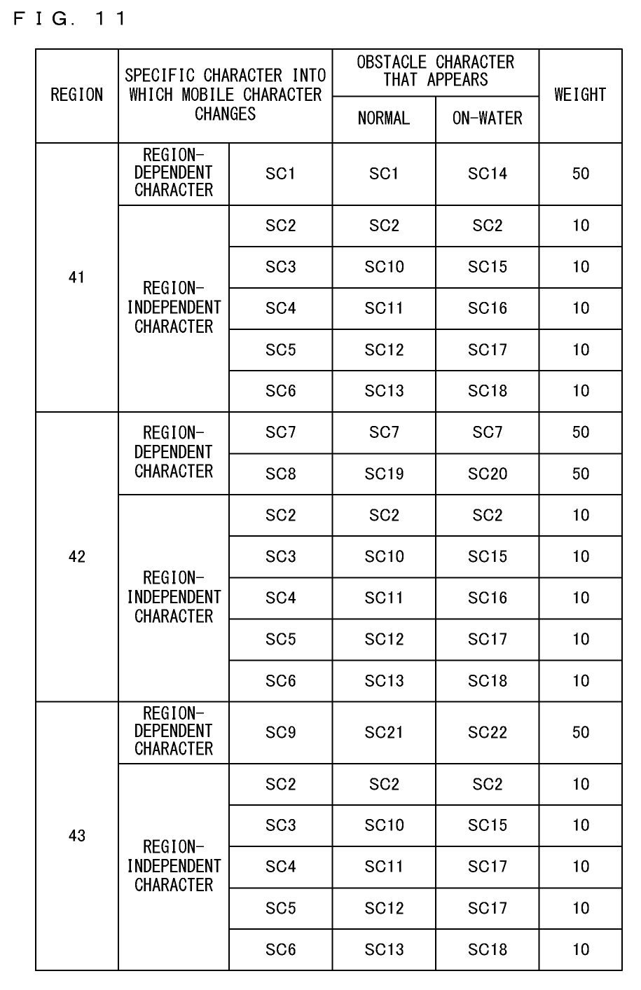

FIG. 9 shows an example of a game image displayed after the game image shown in FIG. 8 was displayed, and after the specific item X hit the leading other mobile character 52. As shown in FIG. 9, when the specific item X hits the other mobile character 52, the other mobile character 52 also changes into the specific character SC1. The third player continues the racing game by operating the specific character SC1 after the change. The specific character SC1 operated by the third player is referred to as “other mobile character SC1 (52)”.

As described above, the plurality of mobile characters hit by the specific item X change into the same character. In the exemplary embodiment, when the specific item X hits a mobile character, one of a plurality of predetermined specific characters is selected. Then, the mobile character hit by the specific item X changes into the selected specific character. Details on which one of the plurality of predetermined specific characters is selected will be described below.

The other mobile character SC1 (51) returns to the original, other mobile character 51 after a first predetermined time has elapsed from the change. Likewise, the other mobile character SC1 (52) returns to the original, other mobile character 52 after the first predetermined time has elapsed from the change.

Even after the specific item X hit the leading other mobile character 52, the specific item X moves forward along the course path.

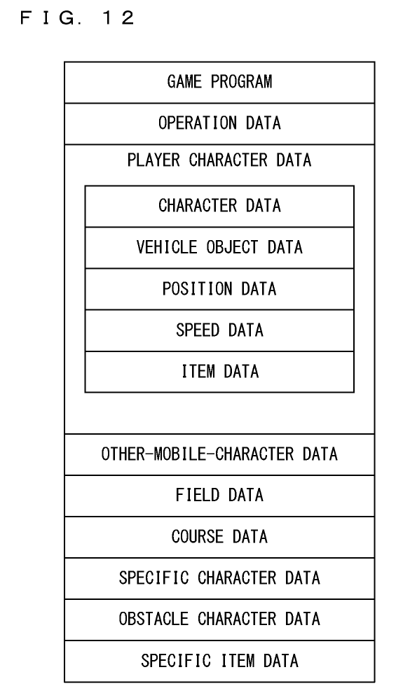

FIG. 10 shows an example of a game image after the game image shown in FIG. 9 was displayed, and after the specific item X hit the leading other mobile character 52. As shown in FIG. 10, when the specific item X has reached a predetermined position that is further ahead of the position of the leading other mobile character 52, an obstacle character SC1 appears at the predetermined position. The predetermined position may be, for example, a position that is a predetermined distance ahead from the position of the other mobile character 52.

The obstacle character SC1 is a character that is an obstacle to traveling of each mobile character. The obstacle character SC1 is, for example, the same type of character as the specific character SC1. The obstacle character SC1, which is of the same type as the specific character SC1, may have a different appearance from the specific character SC1. For example, the obstacle character SC1 may be larger than the specific character SC1. The obstacle character SC1 that appears interferes with traveling of each mobile character. For example, when a mobile character hits the obstacle character SC1, the mobile character may temporarily decelerate or stop. When a mobile character hits the obstacle character SC1, an item held by the mobile character may be deleted. The obstacle character SC1 that appears is deleted after a second predetermined time has elapsed. The specific item X disappears at a predetermined position or a position that is further ahead of the predetermined position.

In the exemplary embodiment, a plurality of types of obstacle characters are stored in advance. The plurality of types of obstacle characters stored in advance include a character different from the specific character, and a character the same as the specific character. When the specific item X is used, any one of the plurality of types of obstacle characters appears.

A plurality of obstacle characters of a single type may appear. The number of obstacle characters that appear may vary depending on the type of obstacle character. For example, when the obstacle character is relatively large, a smaller number of such obstacle characters may appear; whereas when the obstacle character is relatively small, a larger number of such obstacle characters may appear.

The position where the obstacle character appears is not limited to the position ahead of the leading other mobile character, and may be any other position. For example, one or more obstacle characters may appear at a first position ahead of the leading other mobile character 52, and one or more obstacle characters may appear at a second position ahead of a mobile character (e.g., another mobile character 51) other than the leading mobile character.

### Selection of Specific Character and Obstacle Character

Next, a description will be given of which one of a plurality of types of specific characters the other mobile character changes into when a specific item X hits the other mobile character, and which one of a plurality of types of obstacle characters appears. In the exemplary embodiment, among the plurality of types of specific characters, a specific character corresponding to a region on the field where a mobile character having used the specific item X is present is selected, and the mobile character hit by the specific item X changes into the selected specific character. Furthermore, an obstacle character corresponding to the selected specific character appears.

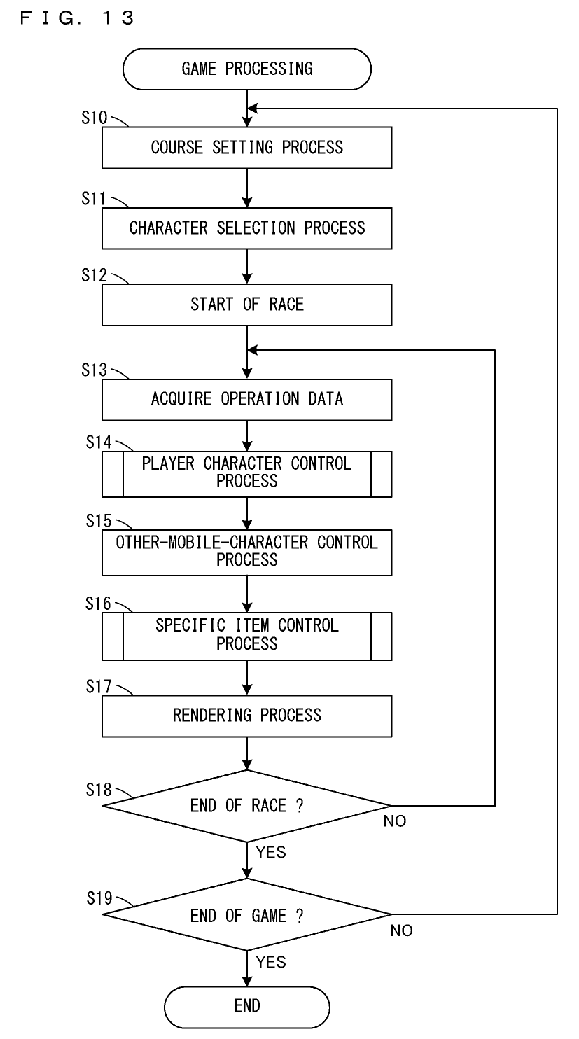

FIG. 11 shows an example of the relationship among a region where a mobile character having used a specific item X is present, a specific character into which a mobile character hit by the specific item X changes, and an obstacle character that appears.

For example, when the player character 50 uses a specific item X, a specific character into which a mobile character changes is selected according to a region where the player character 50 is present when the player character 50 uses the specific item X (when the player makes an instruction to use the specific item X). For example, as shown in FIG. 11, when the player character 50 is within the region 41 and uses the specific item X, one of the specific characters SC1 to SC6 is selected through a lottery process using a random number.

The specific character SC1 is a region-dependent character, and is selected when the specific item X is used in the region 41. Meanwhile, the specific characters SC2 to SC6 are region-independent characters, and are selected in any region on the field. Each specific character is assigned a weight, and the probability of being selected is determined based on the weight. For example, the weight of the region-dependent specific character SC1 is set to “50”, and the weights of the five region-independent specific characters SC2 to SC6 are set to “10”. In this manner, the region-dependent specific character is assigned a larger weight than the region-independent specific characters. One of the plurality of specific characters is selected based on a probability obtained by using the total weight of all the specific characters as a denominator and the weight of each specific character as a numerator. For example, when the player character 50 uses the specific item X in the region 41, the region-dependent specific character SC1 is selected with a probability of “50/100”, and each of the region-independent specific characters SC2 to SC6 is selected with a probability of “10/100”.

Furthermore, as shown in FIG. 11, a specific character into which a mobile character changes and an obstacle character are associated with each other on a one-to-one basis. For example, the specific character SC1 is associated with the obstacle character SC1. The specific character SC2 is associated with the obstacle character SC2. The specific character SC3 is associated with the obstacle character SC10, and the specific character SC4 is associated with the obstacle character SC11.

When a specific item X is used, an obstacle character corresponding to a specific character into which each mobile character changes, appears in the virtual space. For example, when each mobile character changes into the specific character SC1, the obstacle character SC1 usually appears. When each mobile character changes into the specific character SC3, the obstacle character SC10 usually appears. However, if the position where an obstacle character appears is on the water, another obstacle character may appear instead of the normal obstacle character. For example, when each mobile character changes into the specific character SC1, if the position where an obstacle character appears is on the water, the obstacle character SC14 appears instead of the obstacle character SC1. Specifically, when the specific item X has reached a predetermined position that is ahead of the position of the leading mobile character, it is determined whether the predetermined position is on the water. When it is on the water, an on-water specific character appears instead.

When the player character 50 is within the region 42 and uses the specific item X, one of the specific characters SC7, SC8, SC2 to SC6 is selected based on the weight assigned to each specific character. The specific characters SC7 and SC8 are region-dependent characters. A weight of “50” is assigned to each of the region-dependent specific characters SC7 and SC8, and the selection probability of each of the specific characters SC7 and SC8 is “50/150”. Meanwhile, a weight of “10” is assigned to each of the region-independent specific characters SC2 to SC6, and the selection probability of each of the specific characters SC2 to SC6 is “10/150”.

For example, when the mobile character hit by the specific item X changes into the specific character SC7, the obstacle character SC7 appears regardless of whether the appearance position is on the water. Meanwhile, when the mobile character hit by the specific item X changes into the specific character SC8, the obstacle character SC19 usually appears. However, if the appearance position is on the water, the obstacle character SC20 appears instead.

When the player character 50 uses the specific item X while being within the region 43, one of the specific characters SC9 and SC2 to SC6 is selected based on the weight assigned to each specific character. The specific character SC9 is a region-dependent character. A weight of “50” is assigned to the region-dependent specific character SC9, and the selection probability of the specific character SC9 is “50/100”. Meanwhile, a weight of “100” is set to each of the region-independent specific characters SC2 to SC6, and the selection probability of each of the specific characters SC2 to SC6 is “10/100”.

For example, when the mobile character hit by the specific item X changes into the specific character SC9, the obstacle character SC21 usually appears. However, if the appearance position is on the water, the obstacle character SC22 appears instead.

Also, in regions other than the regions shown in FIG. 11, a plurality of region-independent specific characters and one or more region-dependent specific characters are set for each region where an instruction to use the specific item X is made. The region-dependent specific characters are more likely to be selected than the region-independent specific characters.

As described above, a mobile character hit by a specific item X changes into a specific character according to a region in the field where an instruction to use the specific item X is made. This makes it possible to change the appearance of the mobile character, and to impart regional characteristics to the specific character.

A region-dependent specific character may be set to be selectable not only in a single region but also in a plurality of regions. For example, the specific character SC1 may be selectable not only in the region 41 but also in the region 44.

In FIG. 11, a specific character into which a character changes and an obstacle character that appears are associated with each other on a one-to-one basis. However, a specific character into which a character changes and an obstacle character that appears may be associated with each other on a one-to-multiple basis. For example, when a specific character into which a character changes is determined, one of a plurality of obstacle characters corresponding to the specific character may be selected and appear at random through a lottery process, according to a region where an instruction to use a specific item X is performed.

A specific character into which a mobile character changes is determined according to a region where an instruction to use a specific item X is performed, and the specific character is associated with an obstacle character that appears. Therefore, the obstacle character that appears is also determined according to the region where the instruction to use the specific item X is made.

Although the above description is made for the case where the player character 50 uses a specific item X, the same applies when another mobile character uses a specific item X. That is, when another mobile character traveling behind the player character 50 uses a specific item X, the specific item X starts moving from the position of the other mobile character. When the specific item X hits the player character 50, the player character 50 changes into a specific character according to the region where the other mobile character uses the specific item X. The specific character into which the player character 50 changes becomes selectable on the next character selection screen.

For example, initially, each specific character is set to be unselectable on the character selection screen. For example, when the player character 50 hits the specific item X and thereby changes into the specific character SC1, the specific character SC1 becomes selectable on the next character selection screen. Also, when another mobile character hits the specific item X and thereby changes into the specific character SC1, the specific character SC1 is set to be selectable on the character selection screen of the player corresponding to the other mobile character.

As described above, in the racing game of the exemplary embodiment, when a mobile character uses a specific item X, the specific item X moves along a course path. When the specific item X hits a preceding mobile character, the mobile character changes into a specific character depending on the region. Furthermore, an obstacle character that is an obstacle to traveling of mobile characters appears due to the use of the specific item X. By combining the effect of changing the character’s appearance with the effect of placing the obstacle character that is an obstacle to traveling, a new form of interference can be performed in the racing game. The player of the mobile character that is interfered with can recognize that an obstacle character is placed by the fact that the appearance of the character is changed.

In the exemplary embodiment, since an obstacle character appears at a position along the course that is ahead of the leading mobile character, it is possible to interfere with traveling of the leading mobile character, and for example, reduce the gap between the leading mobile character and the mobile characters other than the leading mobile character.

When the mobile character corresponding to each player hits the specific item X and thereby changes into a specific character, the specific character becomes selectable on the next character selection screen of the player corresponding to the changed mobile character. Even when a mobile character is subjected to an attack of another mobile character using the specific item X, a specific character into which the mobile character has changed becomes selectable on the character selection screen, thereby reducing the player’s discomfort caused by the attack. Furthermore, by being subjected to attacks with the specific item X in various regions on the field, the player can increase the number of characters selectable on the character selection screen.

### Details of Game Processing

Next, the details of the game processing performed in the game system 1 will be described. First, data stored in the game system 1 will be described.

FIG. 12 shows an example of various data stored in the game system 1. As shown in FIG. 12, a game program, operation data, player character data, other-mobile-character data, field data, course data, specific character data, obstacle character data, and specific item data are stored in a memory (e.g., the DRAM 27, the storage medium attached to the slot 29, or the flash memory 26) of the game system. In addition to these pieces of data, various data are stored in the memory during a racing game.

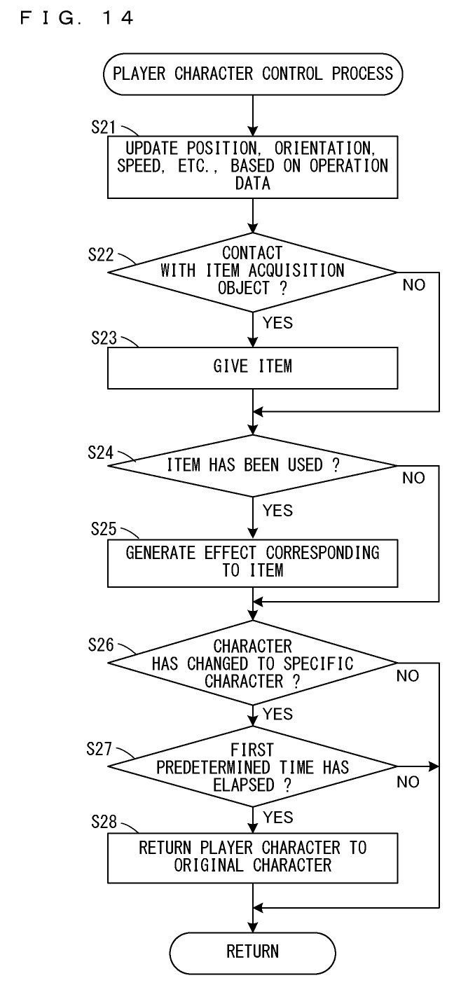

The game program includes instructions for executing game processing described below (processes shown in FIG. 13 to FIG. 15). The game program is stored in the external storage medium or the flash memory 26 in advance, and is loaded into the DRAM 27 when the game is executed.

The operation data is data according to operations on the controller connected to the main body apparatus 2 wirelessly or via wire. The operation data is transmitted to the main body apparatus 2 from the controllers 3 and 4 at predetermined time intervals (e.g., intervals of 1/200 sec).

The player character data is data regarding the player character 50 operated by the player of the main body apparatus 2. The player character data includes character data (3D model data) regarding the shape and appearance of the player character 50, and vehicle object data regarding the vehicle object on which the player character 50 rides. The player character data includes position data indicating the position of the player character 50, and speed data indicating the speed of the player character 50. Moreover, the player character data includes item data regarding items that the player character 50 holds, and use of the items.

The other-mobile-character data is data regarding another player character (another mobile character) operated by another player, or data regarding another mobile character automatically operated by the processor 21. The other-mobile-character data includes data regarding each of the mobile characters. The other-mobile-character data includes data similar to the player character data.

The field data is data representing the entirety of the field F, and includes data representing terrains (e.g., roads, grass, sand, etc.) as well as water.

The course data is data regarding a course selected by the player. The course data includes data regarding a start point, a goal point, and a course path from the start point to the goal point along which a mobile character moves.

The specific character data is data regarding each specific character. The specific character data includes data (3D model data) regarding the shape and appearance of each specific character. The specific character data includes data regarding the corresponding region and data regarding the corresponding weight shown in FIG. 11. Moreover, the specific character data includes a flag indicating whether each specific character is selectable on the character selection screen.

The obstacle character data is data regarding each obstacle character that appears due to use of the specific item X. The obstacle character data includes data (3D model data) regarding the shape and appearance of each obstacle character. The obstacle character and the specific character may be the same character, that is, they may have the same shape and appearance, or they may be different characters. Therefore, the plurality of types of obstacle characters include characters that are the same as the specific characters and characters that are different from the specific characters. Even if an obstacle character is the same character as a specific character, the obstacle character has shape and appearance data (3D model data) that are separate from those of the specific character. However, when an obstacle character that is an obstacle to traveling and a specific character into which a mobile character changes are of the same character type, the shape and appearance data may be shared.

The specific item data is data regarding the above specific item X. The specific item data includes data (3D model data) indicating the shape and appearance of the specific item X, data regarding the hitting determination region of the specific item X, data indicating the position and speed of the specific item X, and data regarding a region where the specific item X is used (region where a use instruction is made).

### Game Processing

Next, a game processing performed in the game system 1 will be described. FIG. 13 is a flowchart showing an example of the game processing. The game processing is started when the player makes an instruction to start the game.

In the exemplary embodiment, the processor 21 of the main body apparatus 2 executes the game program using a memory (e.g., DRAM 27), thereby executing processes in steps shown in FIG. 13 to FIG. 15. However, in other embodiments, some of the processes in the respective steps may be executed by a processor (e.g., a dedicated circuit) other than the processor 21. In a case where the game system 1 is communicable with another information processing apparatus (e.g., the server), some of the processes in the respective steps may be executed on the other information processing apparatus. The processes in the respective steps are merely examples. As long as the same result is obtained, the processing order of the steps may be changed or another process may be executed in addition to (or instead of) the process in each step.

As shown in FIG. 13, first, the processor 21 executes a course setting process (step S10). Here, based on a selection operation performed by the player, the processor 21 determines a course to be used for the race, from among a plurality of courses respectively defined in partial regions of the field, and sets the determined course in the field. Each course has a course path defined from a start point to a goal point. Furthermore, in step S10, the processor 21 determines whether the racing game is to be played in a multiplayer mode or in a single-player mode, based on an operation performed by the player.

Next, the processor 21 executes a character selection process (step S11). Specifically, the processor 21 displays a character selection screen, and receives an input from the player. Based on a selection operation performed by the player, the processor 21 selects one of a plurality of selectable characters. Furthermore, the processor 21 determines the selected character as a player character, based on a determination operation performed by the player. Initially, on the character selection screen, the specific character is set to be unselectable, and the normal characters other than the specific character are set to be selectable. A character that is unselectable may either not be displayed on the character selection screen, or may be displayed but set to be unselectable. The specific character that is set to be selectable in a specific item control process described below becomes selectable by the player on the character selection screen. In step S11, a vehicle object that the player character rides is also selected. Specifically, the processor 21 displays the vehicle object selection screen, and selects one of a plurality of vehicle objects, based on a selection operation performed by the player. Furthermore, the processor 21 determines the selected vehicle object as a vehicle object to be used in the racing game, based on a determination operation performed by the player.

Next, the processor 21 places the plurality of mobile characters including the player character 50 selected in the character selection process, at the start point of the set course, and starts the race (step S12).

When the race has started, the processor 21 acquires the operation data transmitted from the controllers 3 and 4 (step S13). Thereafter, the processor 21 repeatedly executes the processes in steps S13 to S18 at predetermined frame time intervals (e.g., intervals of 1/60 sec).

Next, the processor 21 executes a player character control process (step S14). Here, based on the operation data, the processor 21 updates the position, orientation, speed, movement direction, etc., of the player character 50, updates the item holding state, etc., and causes the player character 50 to use an item. Furthermore, the processor 21 updates the position of the virtual camera according to the update of the position of the player character 50. Hereinafter, the player character control process will be described in detail.

### Player Character Control Process

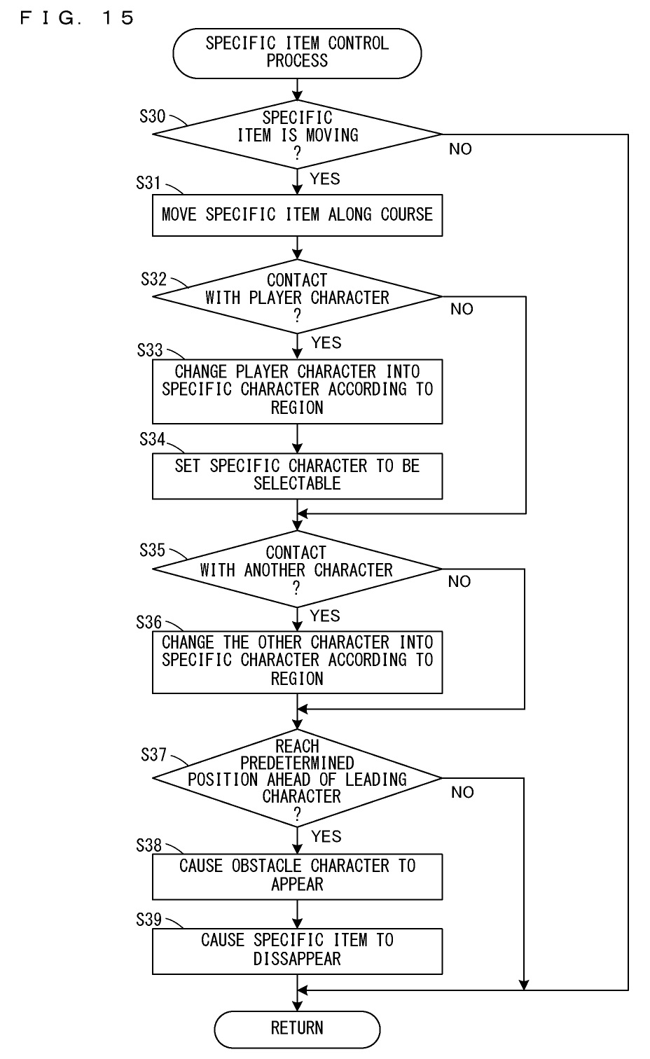

FIG. 14 is a flowchart showing an example of the player character control process in step S14.

As shown in FIG. 14, the processor 21 updates the position, orientation, speed, movement direction, etc., of the player character 50, based on the operation data (step S21). For example, when the A button is being pressed, the processor 21 moves the player character 50 by a predetermined distance in the orientation of the player character 50. Furthermore, the processor 21 updates the orientation of the player character 50 according to left and right inputs to the analog stick of the left controller. Moreover, the processor 21 controls the player character 50 to travel along the set course path.

Next, the processor 21 determines whether the player character 50 comes into contact with the item acquisition object 70, based on the position of the player character 50 and the position of the item acquisition object 70 (step S22).

When the player character 50 comes into contact with the item acquisition object 70 (step S22: YES), the processor 21 gives an item to the player character 50 (step S23). Specifically, the processor 21 determines at random one of a plurality of types of items, based on the current rank of the player character 50, and gives the determined item to the player character 50. For example, if the current rank of the player character 50 is low, the specific item X may be given more easily. However, if there is an item with a higher effect, then when the rank is even lower, the higher-effect item may become more likely to appear, and as a result, the likelihood of giving the specific item X may decrease. When the current rank of the player character 50 is high, the specific item X may be less likely to be given, and when the current rank is the highest, the specific item X may not be given.

When the determination result in step S22 is “NO” or when the process in step S23 has been performed, the processor 21 determines, based on the operation data, whether the item held by the player character 50 has been used (step S24). Specifically, in the state where the player character 50 holds the item, the processor 21 determines whether an item use instruction has been made by the player.

When the item has been used (step S24: YES), the processor 21 generates an effect corresponding to the item (step S25). For example, when the specific item X has been used, the processor 21 generates the effect of the specific item X. Specifically, the processor 21 causes the specific item X to start moving from the position of the player character 50. In addition, the processor 21 stores, as specific item data, information indicating a region where the specific item X was used (region where a use instruction was made).

When the determination result in step S24 is “NO” or when the process in step S25 has been performed, the processor 21 determines whether the player character 50 has changed into a specific character (step S26). Here, the processor 21 determines whether the player character 50 selected on the player selection screen has changed into the specific character as a result of contact with the specific item X. Change of the player character 50 into a specific character will be described in step S16 below.

When the player character 50 has changed into the specific character (step S26: YES), the processor 21 determines whether a first predetermined time has elapsed from the change of the player character 50 into the specific character (step S27).

When the first predetermined time has elapsed (step S27: YES), the processor 21 returns the player character, which has changed into the specific character, back to the original character (step S28). Here, the player character, which has changed into the specific character, is returned to the original character that was selected on the character selection screen before starting the racing game.

When the determination result in step S26 is “NO”, when the determination result in step S27 is “NO”, or when the process in step S28 has been performed, the processor 21 ends the player character control process, and returns the game processing to FIG. 13.

If the racing game is played in the multiplayer mode, the processor 21 transmits the result of the processes in steps S21 to S28 as game data to the other main body apparatuses 2.

Referring back to FIG. 13, after the process in step S14, the processor 21 executes an other-mobile-character control process (step S15). Here, the same processes as the processes performed to the player character 50 in the player character control process are performed to each of the other mobile characters. Specifically, when the racing game is played in the multiplayer mode, the processor 21 receives game data from another main body apparatus 2, and updates the position, orientation, speed, movement direction, etc., of the corresponding other mobile character, causes the other mobile character to acquire an item, and causes the other mobile character to use an item, based on the received game data. When the other mobile character uses the specific item X, the processor 21 causes the specific item X to start moving from the position of the mobile character, and stores, as specific item data, information indicating a region where the specific item X was used. When the racing game is played in the single-player mode, the processor 21 controls each of the other mobile characters according to a predetermined algorithm.

Next, the processor 21 executes a specific item control process (step S16). Hereinafter, the specific item control process in step S16 will be described in detail.

### Specific Item Control Process

FIG. 15 is a flowchart showing an example of the specific item control process in step S16.

As shown in FIG. 15, the processor 21 determines whether a specific item X is moving in the virtual space (step S30). When the specific item X has started moving in step S14 or S15 and does not disappear yet, the processor 21 determines “YES” in step S30.

When the specific item X is moving (step S30: YES), the processor 21 causes the specific item X to move along the course path (step S31). The speed of the specific item X is higher than the speed of any moving character participating in the racing game.

Next, the processor 21 determines whether the specific item X, which was started to move by the other mobile character, has come into contact with the player character 50 (step S32). Specifically, based on the position of the specific item X and the position of the player character 50, the processor 21 determines whether the hitting determination region for the specific item X has come into contact with the player character 50.

When the specific item X has come into contact with the player character 50 (step S32: YES), the processor 21 changes the player character 50 into a specific character according to the region where the specific item X was used (region where the use instruction was made) (step S33). Specifically, based on the table in which regions and specific characters are associated with each other (see FIG. 11), the processor 21 selects at random one of the plurality of types of specific characters (region-independent characters and region-dependent characters). Then, the processor 21 replaces the character data included in the player character data with the data indicating the selected specific character to change the player character 50 into the specific character. Thus, the player character 50 changes into the specific character, and thereafter, the specific character is controlled as the player character until the first predetermined time elapses. When the racing game is played in the multiplayer mode, the processor 21 adds, to the game data, information indicating that the specific item X came into contact with the player character 50, and transmits the game data to the other main body apparatuses 2.

Next, the processor 21 sets the specific character, into which the player character 50 changed in step S33, to be selectable on the character selection screen (step S34). Specifically, the processor 21 sets a flag indicating “selectable” to the data corresponding to the specific character, into which the player character 50 changed, in the specific character data.

When the determination result in step S32 is “NO” or when the process in step S34 has been performed, the processor 21 determines whether the specific item X, which was started to move by the player character 50, has come into contact with the other mobile character (step S35). Specifically, based on the position of the specific item X and the position of the other mobile character, the processor 21 determines whether or not the hitting determination region for the specific item X has come into contact with the other mobile character. When the racing game is played in the multiplayer mode, the processor 21 may determine whether or not the specific item X has come into contact with the other mobile character, based on the game data received from the corresponding other main body apparatus 2.

When the specific item X has come into contact with the other mobile character (step S35: YES), the processor 21 changes the other mobile character into a specific character according to the region where the specific item X was used (region where the use instruction was made) (step S36).

When the determination result in step S35 is “NO” or when the process in step S36 has been performed, the processor 21 determines whether or not the specific item X has reached a predetermined position, along the course, ahead of the leading mobile character (step S37).

When the specific item X has reached the predetermined position ahead of the leading mobile character (step S37: YES), the processor 21 causes an obstacle character to appear at the predetermined position (step S38). Specifically, the processor 21 causes an obstacle character, which corresponds to the specific character into which the mobile character changes in step S33 or S36, to appear. The processor 21 causes a normal obstacle character to appear when the predetermined position is on the ground, and causes an on-water obstacle character to appear when the predetermined position is on the water. The obstacle character that appears in step S38 disappears after a second predetermined time has elapsed. The second predetermined time is set to be longer than the first predetermined time set in step S27. The second predetermined time may be shorter than or equal to the first predetermined time.

Next, the processor 21 causes the specific item X to disappear (step S39). The processor 21 may cause the specific item X to disappear immediately after the obstacle character was caused to appear, or may cause the specific item X to disappear after a predetermined time has elapsed since the obstacle character was caused to appear.

When the determination result in step S30 is “NO”, when the determination result in step S37 is “NO”, or when the process in step S39 has been performed, the processor 21 ends the specific item control process, and returns the game processing to FIG. 13.

Referring back to FIG. 13, after the process in step S16, the processor 21 executes a rendering process (step S17). Specifically, the processor 21 generates a game image, based on a virtual camera that is placed at a position a predetermined distance away from the player character 50, and outputs the generated game image to the display device (the display 12 or an external display device).

Next, the processor 21 determines whether the race has ended (step S18). For example, the processor 21 determines whether all the mobile characters including the player character 50 have reached the goal point set on the course. If the race has not ended yet (step S18: NO), the processor 21 executes the process in step S13 again.

When the race has ended (step S18: YES), the processor 21 determines whether to end the game (step S19). For example, when a game end instruction has been made by the player, the processor 21 determines “YES” in step S19. When the game is not ended (step S19: NO), the processor 21 executes the process in step S10 again. In step S10, a new course is determined based on a selection operation performed by the player. Furthermore, in the character selection process in step S11, the specific character set in step S34 becomes selectable. This is the end of the game processing shown in FIG. 13.

The processes in the above flowchart are merely examples, and the order, contents, etc., of the processes may be appropriately changed.

As described above, in the game of the exemplary embodiment, among a plurality of courses respectively defined in partial regions of the field in the virtual space, one course is set in the field, a race is started on the course, and a plurality of mobile characters including a player character (operation target character) are caused to compete in the race. During the race, when a specific item use instruction is made by the player, at least one of a plurality of other mobile characters is changed into a specific character (first character), and furthermore, an obstacle character (second character) that is an obstacle to traveling is placed on the course.

Thus, the appearance of the other mobile character can be changed and the second character that is an obstacle to traveling can be placed, thereby enabling a new form of interference in the racing game through a combination of multiple effects.

Furthermore, in the exemplary embodiment, a specific character and an obstacle character are determined from among a plurality of types of characters, based on the location on the field where a specific item use instruction has been made. Thus, the other mobile character can be changed into a character according to the region.

Moreover, in the exemplary embodiment, since the obstacle character is placed at the position, along the course, ahead of the leading mobile character, the obstacle character can be placed at a location where it affects traveling of the leading mobile character while potentially affecting all the mobile characters other than the leading mobile character.

### Modifications

While the exemplary embodiment has been described above, the above exemplary embodiment is merely an example, and the following modifications may be applied, for example.

For example, in the above exemplary embodiment, when a specific item X hits a mobile character, the mobile character changes into a specific character. In other embodiments, not only when a specific item X hits a mobile character but also when a first interference instruction is made, a mobile character may change into a specific character. The first interference instruction is not limited to an instruction to use a specific item X, and may be any instruction performed by the player.

In the above exemplary embodiment, when a specific item X hits a mobile character, one of a plurality of types of specific characters is determined as a specific character into which the mobile character changes, based on the position where the specific item X is used. In other embodiments, when a specific item X hits a mobile character, a specific character into which the mobile character changes may be determined based on the position where the specific item X hits the mobile character.

In the above exemplary embodiment, when the position where an obstacle character appears is a position where placement of a normal obstacle character is inhibited (e.g., on the water), the normal obstacle character is replaced with a character that can be placed at that position (an on-water obstacle character). In other embodiments, when the position where an obstacle character is a position where placement of a normal obstacle character is inhibited, one of a plurality of obstacle characters that can be placed at that position may be determined through a lottery process.

In the above exemplary embodiment, in the process of moving a specific item X as a character along a course, a mobile character is changed into a specific character, and an obstacle character is placed. However, a specific item X may be an object other than a character.

In the above exemplary embodiment, all mobile characters hit by a specific item X are changed into the same character. In other embodiments, when a specific item X hits a plurality of mobile characters, the plurality of mobile characters may be changed into different characters.

In the other embodiments, at least one of all mobile characters hit by the specific item X may be changed into a specific character. For example, only a leading mobile character may be changed into a specific character.

In the above exemplary embodiment, when a specific item X hits a mobile character, only the character is changed, and the vehicle object is not changed. In other embodiments, when a specific item X hits a mobile character, both the character and the vehicle object may be changed.

In the above exemplary embodiment, an obstacle character appears ahead of a leading mobile character. In other embodiments, for example, an object that is an obstacle to traveling, such as a wall, hole, water, or oil, may appear ahead of the leading mobile character.

In other embodiments, when a specific item X is used, an object that is advantageous to a mobile character other than the leading mobile character (e.g., an item that temporarily increases the speed) may appear as the obstacle character in front of the mobile character other than the leading mobile character. The appearance of such an object makes the leading mobile character relatively disadvantageous. Therefore, such an object can be regarded as an obstacle to the leading mobile character.

In the above exemplary embodiment, one specific character is selected from among a plurality of specific characters, according to a region where a specific item X is used, through a lottery process, and an obstacle character corresponding to the determined specific character is caused to appear. In other embodiments, each of a specific character and an obstacle character may be determined according to a region where a specific item X is used, through a lottery process. In addition, a specific character into which a mobile character changes and an obstacle character that appears may be determined from among a plurality of types of characters that belong to the same group.

The above described processes may be executed in any other information processing apparatus or information processing system, instead of the game system 1. The information processing system may be composed of a plurality of apparatuses, and the plurality of apparatuses may be connected via a network (e.g., LAN or the Internet).

The configurations according to the above exemplary embodiment and the modifications thereof may be combined together as desired as long as the configurations do not contradict each other. The above is merely an example of the exemplary embodiment, and various modifications and variations other than the above may be made.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to execute game processing comprising:
based on an operation input, causing an operation target character to travel on a field in a virtual space;
regarding a race involving a plurality of mobile characters including the operation target character, setting a course on the field, the course having been determined as a course to be used for the race from among a plurality of courses respectively defined in partial regions of the field, and starting the race;
on the field, causing the operation target character and the mobile characters to travel along the course, thereby conducting the race; and
during the race, when any one of the mobile characters makes a first interference instruction to other mobile characters,
changing at least one of the other mobile characters into a first character, and
placing a second character that is an obstacle to traveling on the course.

2. The one or more non-transitory computer-readable storage media according to claim 1, wherein
each of the first character and the second character is determined from among a plurality of types of characters, based on a location on the field where the first interference instruction is made.

3. The one or more non-transitory computer-readable storage media according to claim 2, wherein
the plurality of types of characters include characters that are respectively set in association with a plurality of regions defined by dividing the field, and
at least the first character is determined through a lottery process from among candidates including at least a character that is associated with the region including a position on the field where the first interference instruction is made.

4. The one or more non-transitory computer-readable storage media according to claim 3, wherein
the first character is determined through a lottery process from among candidates including at least a character that is associated with the region including a position on the field where the first interference instruction is made, and
the second character is determined through a lottery process from among candidates corresponding to the determined first character.

5. The one or more non-transitory computer-readable storage media according to claim 2, wherein
the game processing further comprises:
before the race, selecting a character to be the operation target character from among a plurality of selectable characters; and
if the first character into which the mobile character is changed due to the first interference instruction is not included in the selectable characters, adding the first character to the selectable characters.

6. The one or more non-transitory computer-readable storage media according to claim 5, wherein
the game processing further comprises returning the mobile character changed into the first character, to the character before the change, after a certain time has elapsed.

7. The one or more non-transitory computer-readable storage media according to claim 1, wherein
the game processing comprises, based on the first interference instruction, placing the second character, at least, at a position along the course that is ahead of the mobile character at the front of the race.

8. The one or more non-transitory computer-readable storage media according to claim 7, wherein
the game processing comprises:
based on the first interference instruction, moving a third character forward along the course, from the position of the mobile character that has made the first interference instruction;
changing the mobile character, which comes into contact with a determination shape that is set in conjunction with the third character during forward movement, into the first character; and
placing the second character after the third character has moved to the front position.

9. The one or more non-transitory computer-readable storage media according to claim 8, wherein
the game processing comprises, when the position where the second character is placed is a position on the field where placement of the second character is inhibited, placing the second character after changing the second character into a character that can be placed.

10. A computer-implemented method comprising:
based on an operation input, causing an operation target character to travel on a field in a virtual space;
regarding a race involving a plurality of mobile characters including the operation target character, setting a course on the field, the course having been determined as a course to be used for the race from among a plurality of courses respectively defined in partial regions of the field, and starting the race;
on the field, causing the operation target character and the mobile characters to travel along the course, thereby performing the race; and
during the race, when any one of the mobile characters makes a first interference instruction to other mobile characters,
changing at least one of the other mobile characters into a first character, and
placing a second character that is an obstacle to traveling on the course.

11. The computer-implemented method according to claim 10, wherein
each of the first character and the second character is determined from among a plurality of types of characters, based on a location on the field where the first interference instruction is made.

12. The computer-implemented method according to claim 11, wherein
the plurality of types of characters include characters that are respectively set in association with a plurality of regions defined by dividing the field, and
at least the first character is determined through a lottery process from among candidates including at least a character that is associated with the region including a position on the field where the first interference instruction is made.

13. The computer-implemented method according to claim 12, wherein
the first character is determined through a lottery process from among candidates including at least a character that is associated with the region including a position on the field where the first interference instruction is made, and
the second character is determined through a lottery process from among candidates corresponding to the determined first character.

14. The computer-implemented method according to claim 11, comprising:
before the race, selecting a character to be the operation target character from among a plurality of selectable characters; and
if the first character into which the mobile character is changed due to the first interference instruction is not included in the selectable characters, adding the first character to the selectable characters.

15. The computer-implemented method according to claim 14, comprising returning the mobile character changed into the first character, to the character before the change, after a certain time has elapsed.

16. The computer-implemented method according to claim 10, comprising, based on the first interference instruction, placing the second character, at least, at a position along the course that is ahead of the mobile character at the front of the race.

17. The computer-implemented method according to claim 16, comprising:
based on the first interference instruction, moving a third character forward along the course, from the position of the mobile character that has made the first interference instruction;
changing the mobile character, which comes into contact with a determination shape that is set in conjunction with the third character during forward movement, into the first character; and
placing the second character after the third character has moved to the front position.

18. The computer-implemented method according to claim 17, wherein
when the position where the second character is placed is a position on the field where placement of the second character is inhibited, the second character is placed after being changed into a character that can be placed.

19. An information processing system comprising:
one or more processors; and
one or more non-transitory computer-readable media having stored therein instructions that, when executed, cause the one or more processors to execute game processing comprising:
based on an operation input, causing an operation target character to travel on a field in a virtual space;
regarding a race involving a plurality of mobile characters including the operation target character, setting a course on the field, the course having been determined as a course to be used for the race from among a plurality of courses respectively defined in partial regions of the field, and starting the race;
on the field, causing the operation target character and the mobile characters to travel along the course, thereby conducting the race; and
during the race, when any one of the mobile characters makes a first interference instruction to other mobile characters,
changing at least one of the other mobile characters into a first character, and
placing a second character that is an obstacle to traveling on the course.

20. The information processing system according to claim 19, wherein
each of the first character and the second character is determined from among a plurality of types of characters, based on a location on the field where the first interference instruction is made.

21. The information processing system according to claim 20, wherein
the plurality of types of characters include characters that are respectively set in association with a plurality of regions defined by dividing the field, and
at least the first character is determined through a lottery process from among candidates including at least a character that is associated with the region including a position on the field where the first interference instruction is made.

22. The information processing system according to claim 21, wherein
the first character is determined through a lottery process from among candidates including at least a character that is associated with the region including a position on the field where the first interference instruction is made, and
the second character is determined through a lottery process from among candidates corresponding to the determined first character.

23. The information processing system according to claim 20, wherein
the game processing further comprises:
before the race, selecting a character to be the operation target character from among a plurality of selectable characters; and
if the first character into which the mobile character is changed due to the first interference instruction is not included in the selectable characters, adding the first character to the selectable characters.

24. The information processing system according to claim 23, wherein
the game processing further comprises returning the mobile character changed into the first character, to the character before the change, after a certain time has elapsed.

25. The information processing system according to claim 19, wherein
the game processing comprises, based on the first interference instruction, placing the second character, at least, at a position along the course that is ahead of the mobile character at the front of the race.

26. The information processing system according to claim 25, wherein
the game processing comprises:
based on the first interference instruction, moving a third character forward along the course, from the position of the mobile character that has made the first interference instruction;
changing the mobile character, which comes into contact with a determination shape that is set in conjunction with the third character during forward movement, into the first character; and
placing the second character after the third character has moved to the front position.

27. The information processing system according to claim 26, wherein
the game processing comprises, when the position where the second character is placed is a position on the field where placement of the second character is inhibited, placing the second character after changing the second character into a character that can be placed.
